(19) United States
(12) Patent Application Publication
(10) Pub. No.: US 2026/0017003 A1
(43) Pub. Date: Jan. 15, 2026

(54) NON-TRANSITORY COMPUTER-READABLE STORAGE MEDIUM STORING INFORMATION PROCESSING PROGRAM

(71) Applicant: BROTHER KOGYO KABUSHIKI KAISHA, Nagoya (JP)

(72) Inventor: Masatoshi Kadota, Takahama (JP)

(21) Appl. No.: 19/336,817

(22) Filed: Sep. 23, 2025

Related U.S. Application Data
(63) Continuation of application No. PCT/JP2024/010211, filed on Mar. 15, 2024.

(30) Foreign Application Priority Data
Mar. 30, 2023 (JP) 2023-055834

(51) Int. Cl. G06F 3/12

(52) U.S. Cl. CPC G06F 3/1284; G06F 3/1222; G06F 3/1238; G06F 3/1247; G06F 3/1274

(57) ABSTRACT

A non-transitory computer-readable storage medium stores an information processing program executable by a processor of an information processing apparatus. The information processing apparatus is loaded with an operating system (OS) that includes OS standard printing software. When executed by the processor in a state where the information processing program is registered as a virtual printing device in the OS standard printing software, the information processing program causes the information processing apparatus to perform operations. The operations includes obtaining a first print job from the OS standard printing software, obtaining pull printing information of the first print job, obtaining a pull print request corresponding to the first print job from a printing device of one or more printing devices connected to the information processing apparatus, and transmitting the first print job to the printing device from which the pull print request is obtained in the obtaining the pull print request.

### REFERENCE TO RELATED APPLICATIONS

This is a continuation application of International Application No. PCT/JP2024/01021 1 filed on March 15, 2024, which claims priority from Japanese Patent Application No. 2023-055834 filed on March 30, 2023. The entire contents of the aforementioned applications are incorporated herein by reference.

### BACKGROUND ART

Pull printing, in which a printer accesses a storage location of a spooled print job, retrieves the print job, and executes printing, is commonly known.

For example, a patent literature describes a printing system that executes such pull printing. The printing system includes an information processing apparatus, a cloud-based print server, and printers. When the information processing apparatus receives a print job input instruction from a user, the information processing apparatus generates print data for executing the print job based on print settings information set by the user, and the print server stores the print data. When the user issues a pull print instruction from a printer, which is closest to the user, of the printers registered on the print server, the print server transmits the stored print data to the printer, and the printer performs printing based on the received print data.

### SUMMARY

The above-described printing system has a print server that transmits print data to a specific printer based on a pull print instruction. Therefore, the system configuration becomes complicated and cannot support local printers.

An object of the present disclosure is to provide a non-transitory computer-readable storage medium storing an information processing program that can achieve pull printing without a server and also support local printers.

According to the present disclosure, a non-transitory computer-readable storage medium stores an information processing program executable by a processor of an information processing apparatus. The information processing apparatus is loaded with an operating system (OS) that includes OS standard printing software. When executed by the processor in a state where the information processing program is registered as a virtual printing device in the OS standard printing software, the information processing program causes the information processing apparatus to perform operations. The operations includes obtaining a first print job from the OS standard printing software, obtaining pull printing information of the first print job, obtaining a pull print request corresponding to the first print job from a printing device of one or more printing devices connected to the information processing apparatus, and transmitting the first print job to the printing device from which the pull print request is obtained in the obtaining the pull print request. The information processing apparatus such as a personal computer (PC) used by a user can execute pull printing in response to a request from the printing device. According to the above configuration, pull printing can be realized without a server, thereby simplifying the configuration of the printing system. In addition, pull printing can be realized by a PC connected offline to the printing device, allowing support for local printers.

### BRIEF DESCRIPTION OF THE DRAWINGS

FIG. 1 is a diagram illustrating an example of an overall configuration of a printing system according to an embodiment.

FIG. 2 is a diagram illustrating an example of flows of data when pull printing is executed in the printing system.

FIG. 3 is a flowchart illustrating an example of a process procedure related to printing by a printer application.

FIG. 4 is a flowchart illustrating an example of a process procedure related to printing by a processor of a printer.

FIG. 5 is a block diagram illustrating an example of hardware configurations of a client PC and a printer.

### DESCRIPTION

Embodiments of the present disclosure will be described with reference to the drawings.

### Overall Configuration of Printing System

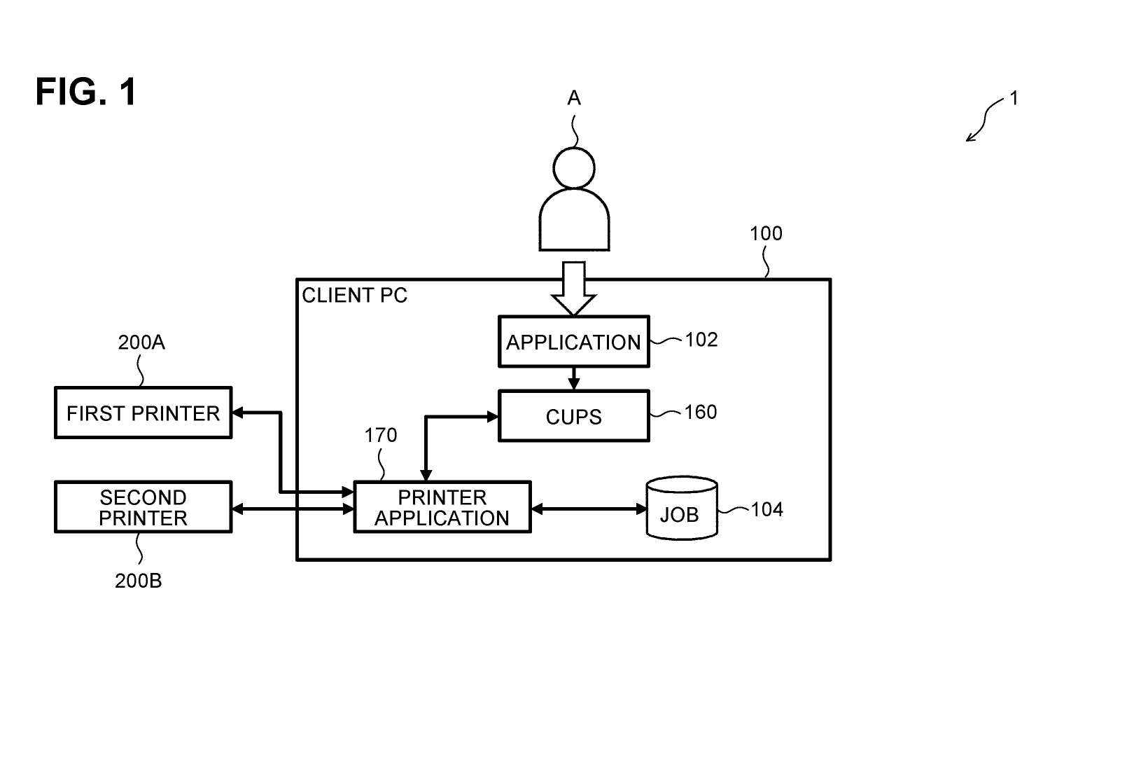

FIG. 1 is a diagram illustrating an example of an overall configuration of a printing system 1 according to an embodiment. As illustrated in FIG. 1, the printing system 1 includes a client PC 100, a first printer 200A and a second printer 200B. The client PC 100 is a terminal device used by, for example, a user A, and is communicably connected to the first printer 200A and the second printer 200B through, for example, a wireless LAN, a wired LAN, or a universal serial bus (USB) cable. The client PC 100 may be connected to the first printer 200A and the second printer 200B by different communication means. The client PC 100 is an example of an information processing apparatus, and the printer 200 is an example of a printing device.

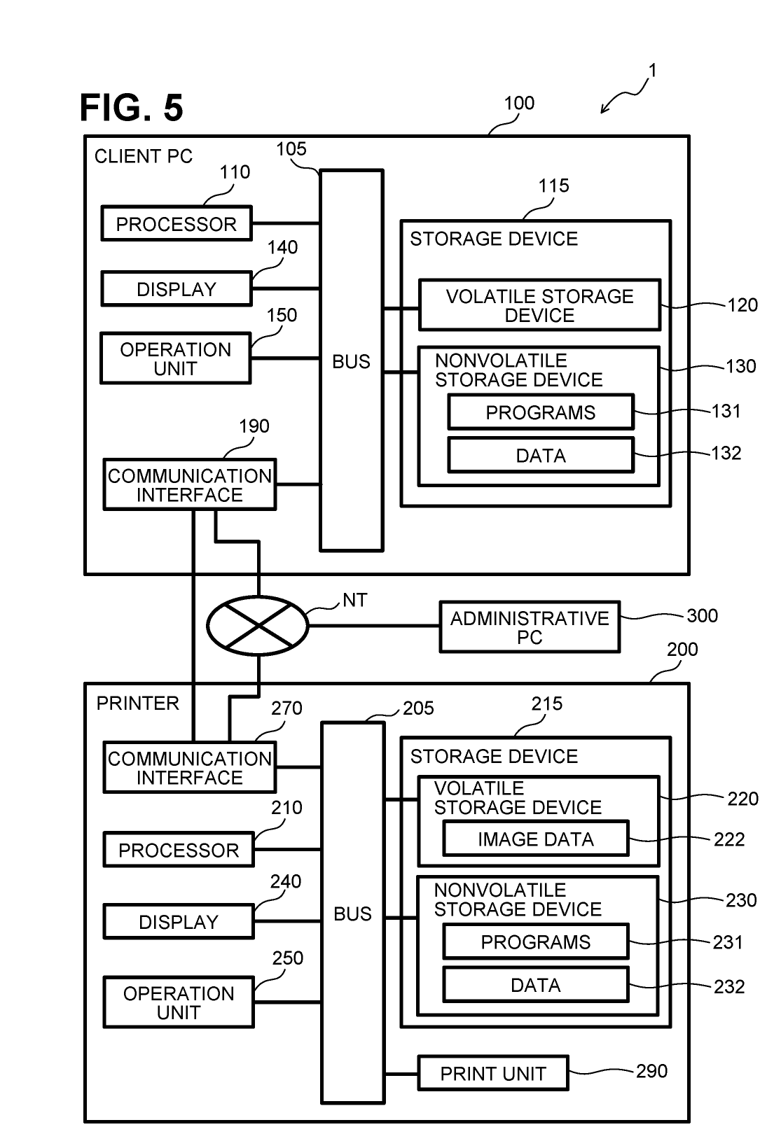

The client PC 100 transmits print data to the first printer 200A and the second printer 200B, causing them to perform printing. The client PC 100 is, for example, a desktop PC, a notebook PC, or a tablet computer, but may be a portable terminal such as a smartphone. The client PC 100 includes a processor 110 and a storage device 115 that stores various information processing programs (refer to FIG. 5 described later). By executing various information processing programs, the processor 110 enables the client PC 100 to have a functional configuration illustrated in FIG. 1. The processor 110 is an example of a processor.

The client PC 100 is loaded with an operating system (OS) having a Common UNIX Printing System (CUPS) 160. The client PC 100 includes an editing application 102, the CUPS 160, a printer application 170, and a job storage unit 104. The editing application 102 outputs a print job to the CUPS 160 based on input from the user A. The CUPS 160 is a modular printing program for the OS, which is installed in the OS as a standard and can execute driverless printing without the need to use a driver provided by a printer vendor. The CUPS 160 is an example of OS standard printing software, and the printer application 170 is an example of an information processing program.

The printer application 170 is registrable in the CUPS 160 as a virtual printer corresponding to the first printer 200A and the second printer 200B connected to the client PC 100. The CUPS 160 manages the printer application 170 as a virtual printer and executes various processes related to printing. The various processes include, for example, a capability information acquisition process and a print data transmission process. In the capability information acquisition process, the CUPS 160 requests capability information from the printer application 170, and the printer application 170 obtains attributes representing capabilities from the printers 200A and 200B, converts the obtained attributes according to whether the CUPS 160 can handle the attributes, whether there are function restrictions, and other relevant criteria, and outputs the converted attributes to the CUPS 160. In response to the print data transmission process of the CUPS 160, the printer application 170 obtains print data from the CUPS 160. The print data corresponds to the attributes output in the capability information acquisition process of the CUPS 160. The printer application 170 converts the obtained print data according to the attributes, function restrictions, and other elements of the printers 200A and 200B, and transmits the converted print data to the printers 200A and 200B.

The print jobs output from the CUPS 160 to the printer application 170 include those having pull printing information and those not having pull printing information. The printer application 170 temporarily spools a print job having pull printing information in the job storage unit 104. The printer application 170 transmits identification information of the print job spooled in the job storage unit 104 to the printers 200A and 200B. The printer application 170 obtains a pull print request corresponding to the print job from at least one of the printers 200A and 200B to which the identification information was transmitted, and transmits the print job to the printer 200 as a request source of the pull print request. In contrast, the printer application 170 transmits a print job not having pull printing information (in other words, a print job having push printing information) to the printer 200A or 200B corresponding to the print job and allows the printer to execute printing. The details of these processes will be described later. The job storage unit 104 is, for example, a data storage area 132 of a nonvolatile storage device 130 of the storage device 115 of the client PC 100 (refer to FIG. 5 described later).

In the present embodiment, the first printer 200A and the second printer 200B are simply referred to as "printer(s) 200" when they are not distinguished from each other. The system configuration of the printing system 1 described above is an example, and the system configuration may be other than the above. For example, the printing system 1 may have more than one client PC 100. The connection between the client PC 100 and the printers 200 is not limited to via the USB, but may be a network connection via the Internet, a wired LAN, a wireless LAN, or similar methods.

### Flows of Data during Pull Printing

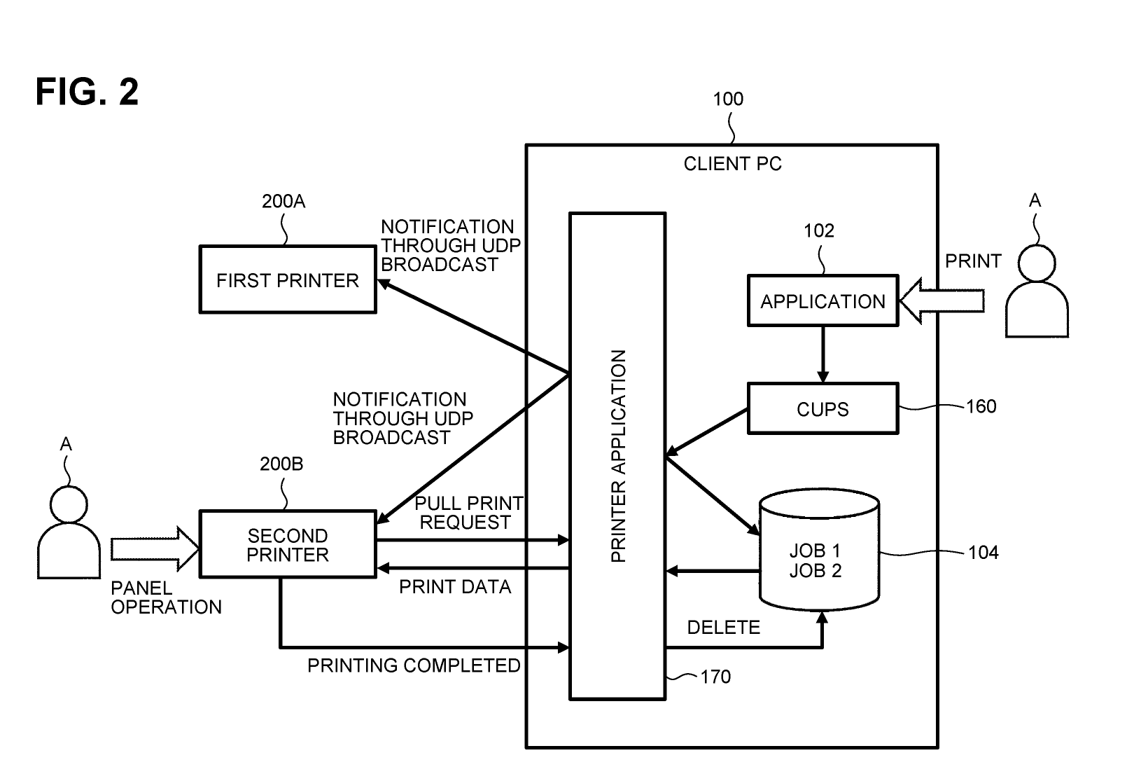

FIG. 2 illustrates an example of flows of data during pull printing in the print system 1. As illustrated in FIG. 2, when the user A issues a print command for pull printing using the editing application 102, the editing application 102 outputs a print job to the CUPS 160 based on input from the user A. When the CUPS 160 outputs the print job to the printer application 170, the printer application 170 obtains pull printing information included in the print job and stores the information in the job storage unit 104. The printer application 170 notifies all the printers 200A and 200B in the printing system 1 that the pull print job has been spooled through, for example, a User Datagram Protocol (UDP) broadcast. In each of the printers 200A and 200B, a display 240 (refer to FIG. 5) shows a list of identification details for spooled print jobs.

A pull print request for a print job is output from one of the printers 200A and 200B. In the example illustrated in FIG. 2, the user A operates an operation unit 250 (refer to FIG. 5 described later) of the second printer 200B, to transmit a pull print request for a print job from the second printer 200B to the printer application 170 of the client PC 100. The printer application 170 obtains a print job corresponding to the received pull print request from the job storage unit 104 and transmits the print job to the second printer 200B. When the second printer 200B finishes printing the print job, the second printer 200B transmits a print completion notification to the printer application 170. The printer application 170 deletes, from the job storage unit 104, the print job for which the print using pull printing has been completed.

The example shown in FIG. 2 illustrates a case in which the user A prints a created file containing highly sensitive information using the second printer 200B, which is located in a place with a lower security level where access by others is not restricted.

### Processing Procedure for Printing by Printer Application

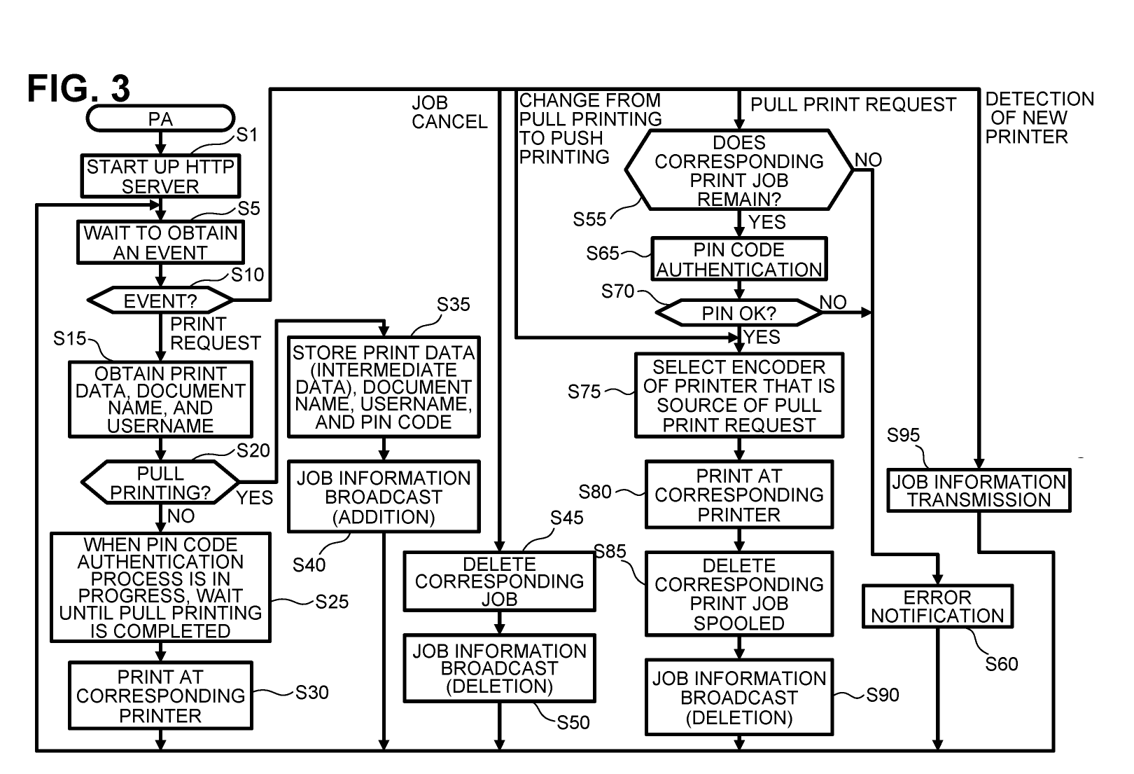

FIG. 3 illustrates an example of a processing procedure related to printing by the printer application 170.

In step S1, the printer application 170 starts up an HTTP (Hypertext Transfer Protocol) server. The HTTP server, which is server software operating on the CUPS 160, obtains information and functions entered by the user A or provides information and functions to the user A by using the HTTP protocol via a browser.

In step S5, the printer application 170 waits to obtain an event. Examples of the event include reception of a print request, a job cancel request, a request for changing from pull printing to push printing, and a pull print request, and detection of a new printer.

In step S10, the printer application 170 determines the type of event that occurred in step S5. For the event triggered by the reception of the print request from the CUPS 160, the process proceeds to the next step S15.

In step S15, the printer application 170 obtains a print job. The print job includes print data, a document name, and a username. A print job using pull printing further includes authentication information such as a Personal Identification Number (PIN) code. The PIN code is an example of pull printing information and first authentication information.

In step S20, the printer application 170 determines whether the print job uses pull printing or push printing based on the contents of the print job obtained in step S15. For example, for a print job not including a PIN code, the printer application 170 determines that the print job uses push printing (step S20: No), and the process proceeds to the next step S25.

The print job not including the PIN code is an example of a second print job. When the determination in step S20 is No, the printer application 170 obtains a print execution instruction for a print job using push printing. The determination of No in step S20 is an example of obtaining a print execution instruction.

In step S25, the printer application 170 determines whether the PIN code authentication process is in progress in response to a pull print request from the printer 200 that is the print execution target of the print job. The determination processing in step S25 is an example of determining whether the authentication is in progress. When the printer application 170 determines that the PIN code authentication process is in progress, the printer application 170 does not transmit the print job but waits until the pull printing is completed. In contrast, when the printer application 170 determines that the PIN code authentication process is not in progress, the process immediately proceeds to step S30.

In step S30, the printer application 170 transmits the print job to the printer 200, which is the target of the print job, and allows the printer 200 to execute the print job. Then, the process returns to step S5. In the above-described steps S25 and S30, when processing in response to a pull print request, such as a PIN code authentication process described later, is in progress, the printer application 170 waits until the processing in response to the pull print request is completed; when such processing is not in progress, the printer application 170 transmits the print job to the corresponding printer 200. This is an example of transmitting the second print job.

In step S20, the printer application 170 determines that a print job including a PIN code uses pull printing (step S20: Yes), and the process proceeds to the next step S35. The print job including the PIN code is an example of a first print job. When the determination in step S20 is Yes, the printer application 170 obtains a print job using pull printing. The determination of Yes in step S20 is an example of obtaining a first print job.

In step S35, the printer application 170 stores the print job, that is, print data, a document name, a username, and a PIN code included in the print job in the job storage unit 104. The print data is intermediate data before being converted in step S75, which will be described later. Step S35 is an example of obtaining pull printing information.

In step S40, the printer application 170 transmits, through a UDP broadcast, an addition request for adding identification information of the print job stored in step S35 to all the printers 200A and 200B in the printing system 1. The identification information is, for example, a document name or a username. This allows the identification information of the spooled print jobs to be shown in the job list on the display 240 of each of the printers 200A and 200B. Then, the process returns to step S5. Step S40 is an example of transmitting identification information of the first print job.

For the event triggered by the reception of the job cancel request from the HTTP server in step S10, the process proceeds to the next step S45.

In step S45, the printer application 170 deletes a print job corresponding to the job cancel request from the job storage unit 104.

In step S50, the printer application 170 transmits, through a UDP broadcast, a deletion request for deleting identification information of the print job deleted in step S45 to all the printers 200A and 200B in the printing system 1. This deletes the identification information of the deleted print job from the job list on the display 240 of each of the printers 200A and 200B. Then, the process returns to step S5.

For the event triggered by the reception of a pull print request from any of the printers 200 in step S10, the process proceeds to the next step S55.

In step S55, the printer application 170 obtains the pull print request. The pull print request includes a PIN code, which is entered via the operation unit 250 of the printer 200 and corresponds to a print job to be requested for pull printing. Step S55 is an example of obtaining a pull print request. The printer application 170 determines whether a print job corresponding to the obtained pull print request remains in the job storage unit 104. When the printer application 170 determines that the print job corresponding to the pull print request has been deleted from the job storage unit 104 due to, for example, a job cancellation or a printing execution by another printer 200 (step S55: No), the process proceeds to the next step S60.

In step S60, the printer application 170 sends an error notification. In the error notification, for example, a message such as "No print job available, cannot print" may be displayed on a display 140 (refer to FIG. 5 described later). Then, the process returns to step S5.

In contrast, in step S55, when the printer application 170 determines that the print job corresponding to the pull print request remains in the job storage unit 104 (step S55: Yes), the process proceeds to the next step S65.

In step S65, the printer application 170 obtains the PIN code from the printer 200, which is the request source, based on the pull print request obtained in step S55. The printer application 170 performs pull print authentication for the print job based on the PIN code of the print job corresponding to the pull print request stored in step S35 and the PIN code obtained from the printer 200. The PIN code obtained from the printer 200 is an example of second authentication information, and step S65 is an example of obtaining second authentication information.

In step S70, the printer application 170 determines whether the authentication in step S65 has succeeded. Specifically, the printer application 170 determines whether the PIN code of the print job corresponding to the pull print request stored in step S35 matches the PIN code obtained from the printer 200. When the PIN codes do not match, the printer application 170 determines that the authentication has failed (step S70: No), and proceeds to the above-described step S60 to issue an error notification. In the error notification, for example, a message such as "Unable to print due to authentication failure" may be displayed on the display 140. In contrast, when the PIN codes match, the printer application 170 determines that the authentication has succeeded (step S70: Yes), and proceeds to the next step S75. A sequence of above-described steps S65 and S70 is an example of performing authentication.

In step S75, the printer application 170 selects an encoder of the printer 200 that is the source of the pull print request, and converts the print data by using the selected encoder. That is, the printer application 170 converts print data in a predetermined data format (e.g., PWG Raster) included in a print job into print data in a predetermined data format (e.g., PCL) compatible with the printer 200 that is the source of the pull print request. The printer 200 that is a source of the pull print request is an example of a printing device from which the pull print request is obtained, and the data format of the print data before conversion is an example of a first format, and the data format of the print data after conversion is an example of a second format. Step S75 is an example of converting print data.

In step S80, the printer application 170 transmits the print job including the print data in the data format converted in step S75 to the printer 200 that is the source of the pull print request, and allows the printer 200 to execute printing. Step S80 is an example of transmitting the first print job.

In step S85, the printer application 170 deletes a spooled print job, which corresponds to the print job transmitted in step S80, from the job storage unit 104. Step S85 is an example of deleting the first print job.

In step S90, the printer application 170 transmits, through a UDP broadcast, a deletion request for deleting identification information of the print job deleted in step S85 to all the printers 200A and 200B in the printing system 1. This deletes the identification information of the deleted print job from the job list on the display 240 of each of the printers 200A and 200B. Then, the process returns to step S5. Step S90 is an example of transmitting a deletion request.

For the event triggered by the reception of a request from the HTTP server to change from pull printing to push printing in step S10, the printer application 170 proceeds to step S75 without passing through steps S55 to S70. In this case, the printer application 170 executes steps S75 to S90, and returns to step S5.

When the event is detection of a new printer 200 in step S10, the process proceeds to step S95. The printer application 170 can detect a new printer 200 using, for example, the multicast Domain Name System/Service Discovery (mDNS/SD) protocol.

In step S95, the printer application 170 transmits, through a UDP broadcast, an addition request for adding the identification information of all the print jobs, which are stored in step S35 and remain in the job storage unit 104, to the newly detected printer 200. This allows the identification information of the spooled print jobs to be shown in the job list on the display 240 of the new printer 200. Then, the process returns to step S5. Step S95 is also an example of transmitting identification information of the first print job. This concludes the explanation of the above flowchart.

### Processing Procedure for Printing by Printer

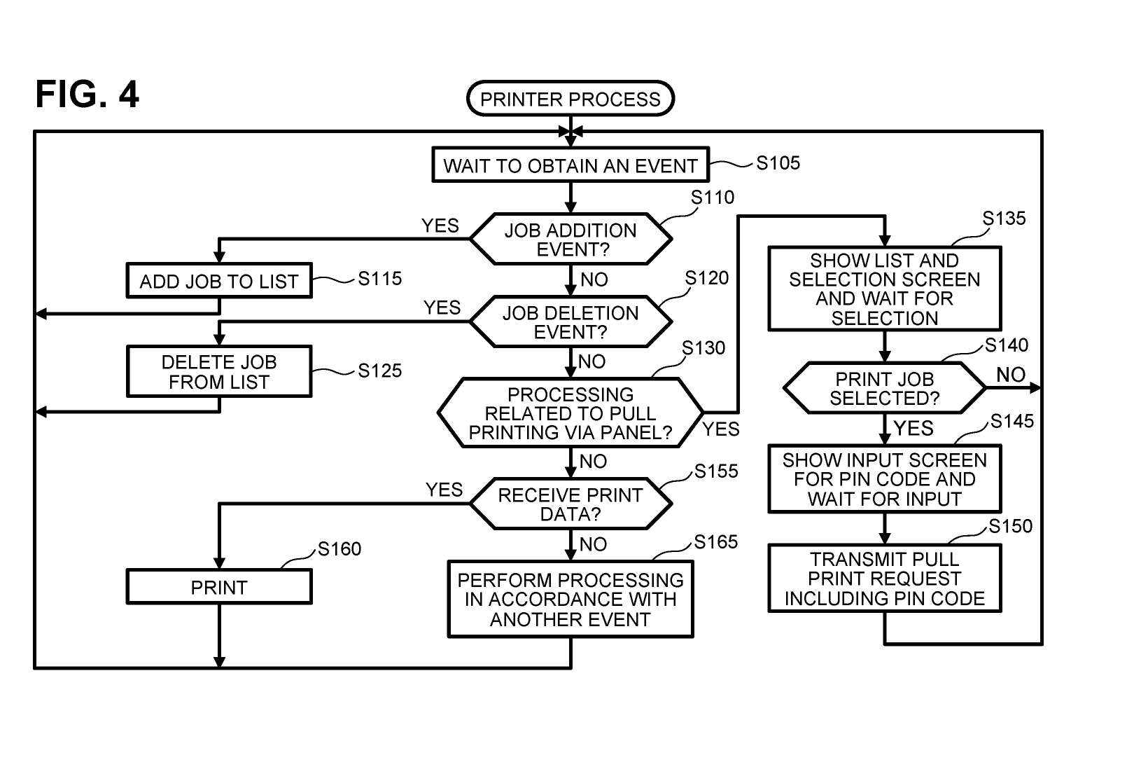

FIG. 4 illustrates an example of a processing procedure related to printing by the processor 210 (refer to FIG. 5 described later) of the printer 200. In step S105, the processor 210 of the printer 200 waits to obtain an event. Examples of the event include a job addition request, a job deletion request, pull printing, and reception of print data.

In step S110, the processor 210 of the printer 200 determines whether the obtained event has occurred in response to the processor 210 receiving an addition request for adding identification information of a print job from the printer application 170 of the client PC 100. The addition request for adding the identification information of the print job is transmitted from the printer application 170 of the client PC 100 in the above-described step S40 or step S95, for example. When the processor 210 receives the addition request (step S110: Yes), the process proceeds to the next step S115.

In step S115, the processor 210 of the printer 200 adds the identification information of the print job as the target of the addition request received in step S110 to the job list. Then, the process returns to step S105.

In contrast, when the processor 210 of the printer 200 has not received the addition request in step S110 (step S110: No), the process proceeds to the next step S120.

In step S120, the processor 210 of the printer 200 determines whether the obtained event has occurred in response to the processor 210 receiving a deletion request for deleting the identification information of the print job from the printer application 170 of the client PC 100. The deletion request for deleting the identification information of the print job is transmitted from the printer application 170 of the client PC 100 in, for example, the above-described step S50 or step S90. When the processor 210 receives the deletion request (step S120: Yes), the process proceeds to the next step S125.

In step S125, the processor 210 of the printer 200 deletes the identification information of the print job, which is the target of the deletion request received in step S120, from the job list. Then, the process returns to step S105.

In contrast, when the processor 210 of the printer 200 has not received a deletion request in step S120 (step S120: No), the process proceeds to the next step S130.

In step S130, the processor 210 of the printer 200 determines whether the obtained event has occurred in response to execution of processing related to pull printing via the operation unit 250 such as an operation panel. When the processing relating to the pull printing is executed, that is, when printing with a PIN code is performed (step S130: Yes), the process proceeds to the next step S135.

In step S135, the processor 210 of the printer 200 allows the display 240 to show a job list of print jobs using pull printing and a selection screen for selecting a print job, and waits for a selection entered by the user. The job list is updated when a job is added in step S115 or deleted in step S125.

In step S140, the processor 210 of the printer 200 determines whether a print job has been selected on the selection screen displayed in step S135. When the processor 210 determines that no print job has been selected (step S140: No), the process returns to the step S105. In contrast, when the processor 210 determines that a print job has been selected (step S140: Yes), the process proceeds to the next step S145.

In step S145, the processor 210 of the printer 200 allows the display 240 to show an input screen for a PIN code corresponding to the print job as the pull print request target, and waits for user input.

In step S150, the processor 210 of the printer 200 transmits a pull print request including the PIN code entered on the input screen displayed in step S145 to the printer application 170 of the client PC 100. Then, the process returns to step S105. When the authentication using the PIN code transmitted in the printer application 170 (in step S65) is successful (step S70: Yes), the processor 210 receives the print data, which is to be transmitted in step S80 by the printer application 170, and executes printing. This operation in step S105 is performed as a print data reception event, followed by determinations of "No" in steps S110, S120, and S130, and a determination of "Yes" for the print data reception in step S155.

In contrast, in step S130, when the processor 210 of the printer 200 determines that normal printing that is not printing with a PIN code is executed, in other words, when processing relating to pull printing is not executed (step S130: No), the processor 210 of the printer 200 proceeds to step S155.

In step S155, the processor 210 of the printer 200 determines whether the obtained event has occurred in response to the processor 210 receiving a print job including print data. The print job is transmitted from the printer application 170 of the client PC 100 in the aforementioned step S30, for example. When the processor 210 determines that it receives the print job (step S155: Yes), the process proceeds to the next step S160.

In step S160, the processor 210 of the printer 200 prints based on the print job received in step S155. Then, the process returns to step S105.

In contrast, when the processor 210 of the printer 200 has not received the print job in step S155 (step S155: No), the process proceeds to the next step S165.

In step S165, the processor 210 of the printer 200 performs processing in accordance with another event. Then, the process returns to step S105. The explanation of the above flowchart is thus concluded.

### Effects of Embodiment

The printer application 170 of this embodiment causes the client PC 100 to perform steps S20, S35, S55, and S80. In step S20, a print job is obtained from the CUPS 160. In step S35, pull printing information of the print job is obtained. In step S55, a pull print request corresponding to the print job is obtained from a printer 200 of the printers 200A and 200B. In step S80, the print job is transmitted to the printer 200 from which the pull print request has been obtained in step S55.

According to the present embodiment, the client PC 100 used by the user A can perform pull printing in accordance with a request from the printer 200. According to the present embodiment, pull printing can be realized without a server, thereby simplifying the configuration of the printing system 1. In addition, pull printing can be realized by a client PC 100 connected offline to the printer 200, allowing support for local printers.

In the present embodiment, the printer application 170 causes the client PC 100 to execute step S75. In step S75, the print data in a predetermined data format included in the print job is converted into print data in a data format compatible with the printer 200 from which the pull print request was obtained in step S55. The print job including the print data in the data format converted in step S75 is transmitted to the printer 200 that is the source of the pull print request in step S80. According to the present embodiment, print data included in a print job can be converted into print data corresponding to, for example, specifications and functions of the printer 200 that has requested pull printing, and then transmitted to the printer 200 to execute pull printing. According to the present embodiment, pull printing that supports flexible customization specific to each printer can be achieved.

In the present embodiment, the printer application 170 executes step S85 for deleting the print job stored in the job storage unit 104 after transmitting the print job in step S80. According to the present embodiment, deleting the spooled print job after each pull print operation can reduce the likelihood that extra storage capacity will be needed in the job storage unit 104 for storing print jobs.

In the present embodiment, the printer application 170 executes step S90. After the print job is deleted in step S85, a deletion request for deleting the identification information is transmitted to the printers 200A and 200B in step S90. According to the present embodiment, the identification information of the spooled print job using pull printing is deleted from all the printers 200 each time pull printing is executed. This can prevent the print job, which has been pull-printed, from being displayed on the panel menu of each printer 200.

In the present embodiment, the pull printing information obtained in step S35 includes the PIN code of the print job. The printer application 170 executes step S65 and step S70. In step S65, the PIN code is obtained from the printer 200 from which the pull print request has been obtained in step S55. In step S70, the pull print authentication for the print job is performed based on the PIN code obtained in step S35 and the PIN code obtained in step S65. According to the present embodiment, the print job is pulled and executed on a printer 200 only when, for example, the PIN code set for the print job matches the PIN code entered at the printer 200 that requested pull printing. According to the present embodiment, security can be improved.

In the present embodiment, the printer application 170 causes the client PC 100 to execute steps S20, S25, and S30. In step S20, a print execution instruction for a print job using push printing from the CUPS 160 is obtained. When the print execution instruction is obtained in step S20, the process determines whether authentication in step S65 and step S70 is in progress in step S25. When the authentication is determined to be in progress, the printer application 170 waits without transmitting the print job to the corresponding printer 200. When the authentication is determined not to be in progress, the printer application 170 transmits the print job to the corresponding printer 200. According to the present embodiment, the transmission of other push print jobs to the printer 200 is restricted during the authentication process for pull print execution. According to the present embodiment, while the user is waiting for the creation of a printout by pull printing at the printer 200 where pull printing was requested, the creation of printouts from other push print jobs is prevented from interrupting.

### Modifications

The present disclosure is not limited to the above embodiment, and various modifications can be made without departing from the spirit and technical idea of the present disclosure.

In the above embodiment, a print job using pull printing is spooled on the client PC 100, but the print job may also be spooled externally. For example, the printer job may be spooled on another client PC or an external storage device.

In the above embodiment, the print job is obtained from the CUPS 160 in the same client PC 100, but the location where the print job is spooled is not limited to the inside of the client PC 100 but may be outside of it. For example, the printer may be configured to obtain a print job including a PIN code from another client PC and to perform pull printing.

In the above embodiment, the identification information of the print job corresponding to the pull printing information obtained in step S35 is transmitted to the printers 200A and 200B in steps S40 and S95, but the identification information may not be transmitted. In this case, the job list is no longer displayed on the printer. However, since the person who issues the print command and the person who receives the printout (the person who operates the printer to perform pull printing) are usually the same, the user knows which printer application 170 of client PC 100 holds the print job. Thus, by designating the printer application 170 and the print job's ID or similar information on the panel and entering the PIN code, the user can perform pull printing. This can meet needs such as not displaying a high confidential print job in the menu, that is, ensuring that only the user knows such a print job is queued on the printer.

The flow charts shown in FIGS. 3 to 4 are not intended to limit the present disclosure to the procedures shown in the flow charts, and steps may be added, deleted, or changed in order within a range not departing from the spirit and technical idea of the present disclosure.

In addition to what has already been described, the methods of the above embodiment and various modifications may be appropriately combined and utilized.

Although not individually illustrated, the present disclosure may be embodied with various modifications without departing from the spirit thereof.

### Hardware Configurations of Client PC and Printer

An example of hardware configurations of the client PC 100 and the printer 200 will be described with reference to FIG. 5. The first printer 200A and the second printer 200B may have a common hardware configuration.

### Client PC

As illustrated in FIG. 5, the client PC 100 includes a processor 110, a storage device 115, a display 140, an operation unit 150, and a communication interface 190. The processor 110, the storage device 115, the display 140, the operation unit 150, and the communication interface 190 are connected to each other via a bus 105, enabling them to transmit and receive data.

The storage device 115 includes a volatile storage device 120 and a nonvolatile storage device 130. The volatile storage device 120 is, for example, a DRAM, and stores various programs and data to be processed. The nonvolatile storage device 130 is, for example, a hard disk drive or a solid state drive, and has a program storage area 131 and a data storage area 132.

The program storage area 131 stores various programs. The various programs include an information processing program based on the flowchart of FIG. 3 described above. The data storage area 132 stores data necessary for executing various programs.

The processor 110 is a device for performing data processing, for example, a CPU, and executes various programs stored in the program storage area 131. The processor 110 performs various processes including data communication with the printer 200 and an administrative PC 300 connected to the network NT.

The display 140 is, for example, a liquid crystal display, and can display various information. The operation unit 150 is, for example, a mouse or a keyboard, and receives an operation by a user. The user can enter various instructions into the client PC 100 using the operation unit 150.

The communication interface 190 is a wired or wireless network interface for communicating with other devices, and is connected to a USB cable or a network NT.

The storage device 115 is not limited to the configuration of the above-described device elements, and may be configured by, for example, a RAM, a ROM, an EEPROM, an HDD, a portable recording medium such as a USB memory to be attached to or detached from the client PC 100, a buffer provided in the processor 110, or a combination thereof.

The storage device 115 may be a computer-readable storage medium. A computer- readable storage medium is a non-transitory medium. The non-transitory medium includes, in addition to the above-described examples, a recording medium such as a CD-ROM or a DVD- ROM. A non-transitory medium is also a tangible medium. The same applies to a storage device 215 of the printer 200, which will be described later.

### Printer

As illustrated in FIG. 5, the printer 200 includes the processor 210, the storage device 215, the display 240, the operation unit 250, a communication interface 270, and a print unit 290. The processor 210, the storage device 215, the display 240, the operation unit 250, the communication interface 270, and the print unit 290 are connected to each other via a bus 205 so as to be able to transmit and receive data.

The storage device 215 includes a volatile storage device 220 and a nonvolatile storage device 230. The volatile storage device 220 is, for example, a DRAM and includes an image data storage area 222 for storing image data to be printed. The nonvolatile storage device 230 is, for example, an NVRAM, or flash memory, and includes a program storage area 231 and a data storage area 232. The program storage area 231 stores various programs. The various programs include information processing programs based on the flowchart in FIG. 4, and firmware such as a print processing program. The data storage area 232 stores various kinds of data for executing the various programs.

The processor 210 is a device for performing data processing, and is, for example, a CPU. The processor 210 executes various programs stored in the program storage area 231.

The display 240 is, for example, a liquid crystal display, and can display various information. The operation unit 250 is a device for receiving an operation by a user. The user can enter various instructions into the printer 200 using the operation unit 250. The communication interface 270 is a wired or wireless network interface for communicating with other devices, and is connected to a USB cable or a network NT.

The print unit 290 prints an image on a sheet conveyed by a conveying mechanism (not shown). The print unit 290 prints an image on a sheet based on print data transmitted from the client PC 100 or based on a print job generated by the print unit 290 itself in response to an operation performed on the operation unit 250.

While the disclosure has been described in detail with reference to the specific embodiment thereof, this is merely an example, and various changes, arrangements and modifications may be applied therein without departing from the spirit and scope of the disclosure.

What is claimed is:

1. A non-transitory computer-readable storage medium storing an information processing program executable by a processor of an information processing apparatus being loaded with an operating system (OS) that includes OS standard printing software, the information processing program being configured to, when executed by the processor in a state where the information processing program is registered as a virtual printing device in the OS standard printing software, cause the information processing apparatus to perform operations comprising:
obtaining a first print job from the OS standard printing software;
obtaining pull printing information of the first print job;
obtaining a pull print request corresponding to the first print job from a printing device of one or more printing devices connected to the information processing apparatus; and
transmitting the first print job to the printing device from which the pull print request is obtained in the obtaining the pull print request.

2. The non-transitory computer-readable storage medium according to claim 1, wherein the operations further comprise transmitting identification information of the first print job, which corresponds to the pull printing information obtained in the obtaining the pull printing information, to the one or more printing devices.

3. The non-transitory computer-readable storage medium according to claim 1,
wherein the operations further comprise converting print data in a first format included in the first print job into print data in a second format corresponding to the printing device from which the pull print request is obtained in the obtaining the pull print request, and
wherein, in the transmitting the first print job, the first print job including the print data in the second format converted in the converting print data is transmitted to the printing device.

4. The non-transitory computer-readable storage medium according to claim 1, wherein the operations further comprise deleting the first print job stored in the information processing apparatus after transmitting the first print job in the transmitting the first print job.

5. The non-transitory computer-readable storage medium according to claim 4, wherein the operations further comprise
transmitting identification information of the first print job, which corresponds to the pull printing information obtained in the obtaining the pull printing information, to the one or more printing devices, and
transmitting a deletion request for deleting the identification information transmitted in the transmitting identification information, toward the one or more printing devices after deleting the first print job in the deleting the first print job.

6. The non-transitory computer-readable storage medium according to claim 1,
wherein the pull printing information obtained in the obtaining the pull printing information includes first authentication information of the first print job,
wherein the operations further comprise obtaining second authentication information from the printing device from which the pull print request is obtained in the obtaining the pull print request, and performing authentication of the pull printing information of the first print job based on the first authentication and the second authentication information obtained in the obtaining the second authentication information, and
wherein the transmitting the first print job is performed when authentication is successful in the performing authentication.

7. The non-transitory computer-readable storage medium according to claim 6, wherein the operations further comprise
obtaining a print execution instruction for a second print job from the OS standard printing software,
in response to obtaining the print execution instruction, determining whether the authentication is in progress in the performing authentication,
in response to determining that the authentication is in progress, waiting for the second print job to be transmitted to the printing device, and
in response to determining that the authentication is not in progress, transmitting the second print job to the printing device.
